(19) United States
(12) Patent Application Publication
(10) Pub. No.: US 2015/0258983 A1
(43) Pub. Date: Sep. 17, 2015

(54) CONTROL APPARATUS FOR A HYBRID VEHICLE DRIVE SYSTEM

(71) Applicant: TOYOTA JIDOSHA KABUSHIKI KAISHA, Toyota-shi (JP)

(72) Inventor: Shigeru KIMURA, Toyota-shi (JP)

(21) Appl. No.: 14/635,717

(22) Filed: Mar. 2, 2015

(30) Foreign Application Priority Data
Mar. 14, 2014 (JP) 2014-052643

(51) Int. Cl. B60W 20/00; B60K 6/445; B60W 10/08; B60W 30/18

(52) U.S. Cl. CPC B60W 20/108; B60W 30/18036; B60K 6/445; B60W 10/08; Y10S 903/902

(57) ABSTRACT

A control apparatus for a hybrid vehicle drive system, including a clutch release determining portion to detect that a clutch is placed in a released state, a brake release determining portion to detect that a brake is placed in a released state, and a second electric motor drive control portion configured to initiate an operation of a second electric motor to generate a negative torque for a rotating request of an output gear in a reverse direction for reverse driving of the hybrid vehicle, after the clutch release determining portion and the brake release determining portion have detected that the clutch and the brake are placed in the released states.

### CROSS REFERENCE TO RELATED APPLICATION

The present application claims the priority from Japanese Patent Application No. 2014-052643 filed on Mar. 14, 2014, the disclosure of which is herein incorporated by reference in its entirety.

### BACKGROUND OF THE INVENTION

1. Field of the Invention

The present invention relates to an improvement of a control apparatus for a drive system of a hybrid vehicle.

2. Description of Related Art

There is known a hybrid vehicle drive system including: a differential device which comprises a first differential mechanism and a second differential mechanism and which comprises four rotary components; an engine, a first electric motor, a second electric motor and an output rotary member which are respectively connected to said four rotary components; and a plurality of coupling elements. JP-2011-98712 A1 discloses an example of a hybrid vehicle transmission system configured to switch the hybrid vehicle drive system to a selected one of a plurality of vehicle drive modes, according to a selected one of different combinations of operating states of the coupling elements.

In the prior art hybrid vehicle drive system constructed as described above, the second electric motor, for example, is operated in a negative direction to drive the hybrid vehicle in a reverse direction. In some operating states of the plurality of coupling elements during an operation of the second electric motor in the negative direction, the engine and the second electric motor are operated in the same direction, so that there is a risk of an operation of the engine in a reverse direction as a result of the operation of the second electric motor in the negative direction to drive the hybrid vehicle in the reverse direction. This problem was first discovered by the present inventors in the process of an intensive study in an effort to improve the performance of the hybrid vehicle.

### SUMMARY OF THE INVENTION

The present invention was made in view of the background art described above. It is therefore an object of the present invention to provide a control apparatus for a hybrid vehicle drive system, which permits prevention of an operation of the engine in the reverse direction during reverse driving of the hybrid vehicle.

The object indicated above is achieved according to a first aspect of the present invention, which provides a control apparatus for a hybrid vehicle drive system including: a differential device which comprises a first differential mechanism and a second differential mechanism and which comprises four rotary components; an engine, a first electric motor, a second electric motor and an output rotary member which are respectively connected to the above-described four rotary components; and a coupling element which is placed in an engaged state to hold constant a ratio of an output speed of the above-described first differential mechanism or the above-described second differential mechanism to a speed of a rotary motion received from the above-described engine, the control apparatus comprising: a detecting portion configured to detect that the above-described coupling element is placed in a released state; and an electric motor drive control portion configured to initiate an operation of the above-described first electric motor or the above-described second electric motor to generate a negative torque for rotating the above-described output rotary member in a reverse direction for reverse driving request of the hybrid vehicle, after the above-described detecting portion has detected that the above-described coupling element is placed in the released state.

The hybrid vehicle control apparatus according to the first aspect of the invention described above comprises the detecting portion configured to detect that the coupling element is placed in the released state, and the electric motor drive control portion configured to initiate the operation of the first electric motor or the second electric motor to generate the negative torque for rotating the output rotary member in the reverse direction for reverse driving request of the hybrid vehicle, after the detecting portion has detected that the coupling element is placed in the released state. Accordingly, it is possible to prevent the operations of the engine and the first or second electric motor in the same direction, for effectively preventing an operation of the engine in the reverse direction as a result of an operation of the first or second electric motor to generate a negative torque for driving the hybrid vehicle in the reverse direction. Namely, the present invention provides a control apparatus for a hybrid vehicle drive system, which control apparatus permits prevention of an operation of the engine in the reverse direction during reverse driving of the hybrid vehicle.

According to a second aspect of the invention, the hybrid vehicle drive system to be controlled by the control apparatus according to the first aspect of the invention is configured such that the coupling element is a brake configured to selectively fix the rotary component connected to the first electric motor or the second electric motor, to a stationary member. According to this second aspect of the invention, it is possible to effectively prevent the operation of the engine in the reverse direction, by operating the first electric motor or the second electric motor to generate a negative torque for reverse driving of the hybrid vehicle after determining that the brake is placed in a released state when the output rotary member is required to be rotated in a reverse direction.

According to a third aspect of the invention, the hybrid vehicle drive system to be controlled by the control apparatus according to the first aspect of the invention is configured such that the coupling element is a clutch which is placed in an engaged state to limit a differential function of the first differential mechanism or the second differential mechanism. According to this third aspect of the invention, it is possible to effectively prevent the operation of the engine in the reverse direction, by operating the first electric motor or the second electric motor to generate a negative torque for reverse driving of the hybrid vehicle after determining that the clutch is placed in a released state when the output rotary member is required to be rotated in a reverse direction.

According to a fourth aspect of the invention, the hybrid vehicle drive system to be controlled by the control apparatus according to any one of the first, second and third aspects of the invention is configured such that the first differential mechanism comprises a first rotary element connected to the first electric motor, a second rotary element connected to the engine, and a third rotary element, while the second differential mechanism comprises a first rotary element, a second rotary element and a third rotary element, and such that the third rotary element of the first differential mechanism and the third rotary element of the second differential mechanism are connected to each other, and the second rotary element of the second differential mechanism is connected to the output rotary member, while the third rotary element of the second differential mechanism is connected to the second electric motor. According to this fourth aspect of the invention, the control apparatus permits prevention of the operation of the engine in the reverse direction during reverse driving of the hybrid vehicle provided with the drive system having a practical arrangement.

### BRIEF DESCRIPTION OF THE DRAWINGS

FIG. 1 is a schematic view showing an arrangement of a hybrid vehicle drive system to which the present invention is suitably applicable;

FIG. 2 is a block diagram illustrating major portions of a control system provided to control the drive system of FIG. 1;

FIG. 3 is a table indicating combinations of operating states of a clutch and a brake, which correspond to respective four vehicle drive modes to be established in the drive system of FIG. 1;

FIG. 4 is a collinear chart having straight lines which permit indication thereon of relative rotating speeds of various rotary elements of the drive system of FIG. 1, the collinear chart corresponding to drive modes HV1 and EV1 indicated in FIG. 3;

FIG. 5 is a collinear chart having straight lines which permit indication thereon of the relative rotating speeds of the rotary elements of the drive system of FIG. 1, the collinear chart corresponding to a drive mode HV2 indicated in FIG. 3;

FIG. 6 is a collinear chart having straight lines which permit indication thereon of the relative rotating speeds of the rotary elements of the drive system of FIG. 1, the collinear chart corresponding to a drive mode EV2 indicated in FIG. 3;

FIG. 7 is a functional block diagram illustrating major control functions of an electronic control device shown in FIG. 2;

FIG. 8 is a collinear chart having straight lines which permit indication thereon of the relative rotating speeds of the rotary elements of the drive system of FIG. 1 while the brake for fixing the first electric motor to a housing is placed in an engaged state;

FIG. 9 is a collinear chart having straight lines which permit indication thereon of the relative rotating speeds of the rotary elements of the drive system of FIG. 1 while the clutch for limiting a differential function of a first planetary gear set is placed in an engaged state; and

FIG. 10 is a flow chart illustrating a major portion of one example of a reverse driving control implemented by the electronic control device of FIG. 2.

### DETAILED DESCRIPTION OF PREFERRED EMBODIMENT

In the hybrid vehicle drive system to be controlled by the control apparatus according to the present invention, the differential device comprising the first differential mechanism and the second differential mechanism comprises the four rotary components when the above-described clutch disposed between a rotary element of the first differential mechanism and a rotary element of the second differential mechanisms is placed in an engaged state. Preferably, the differential device comprises the four rotary components when the clutch disposed between the second rotary element of the first differential mechanism and the first rotary element of the second differential mechanism is placed in the engaged state. In other words, the present invention is suitably applicable to a hybrid vehicle drive system including: a differential device comprising a first differential mechanism and a second differential mechanism and comprising four rotary components relative rotating speeds of which are represented along a vertical axis in a two-dimensional collinear chart in which relative gear ratios of the first and second differential mechanisms are taken along a horizontal axis; and an engine, a first electric motor, a second electric motor and an output rotary member which are respectively connected to the four rotary components, and wherein one of the four rotary components is constituted by a rotary element of the first differential mechanism and a rotary element of the second differential mechanism which are selectively connected to each other through a clutch, while one of the rotary elements of the first and second differential mechanisms which are selectively connected to each other through the clutch is selectively connected to a stationary member through a brake.

Referring to the drawings, a preferred embodiment of the present invention will be described in detail. It is to be understood that the drawings referred to below do not necessarily accurately represent ratios of dimensions of various elements.

### Embodiment

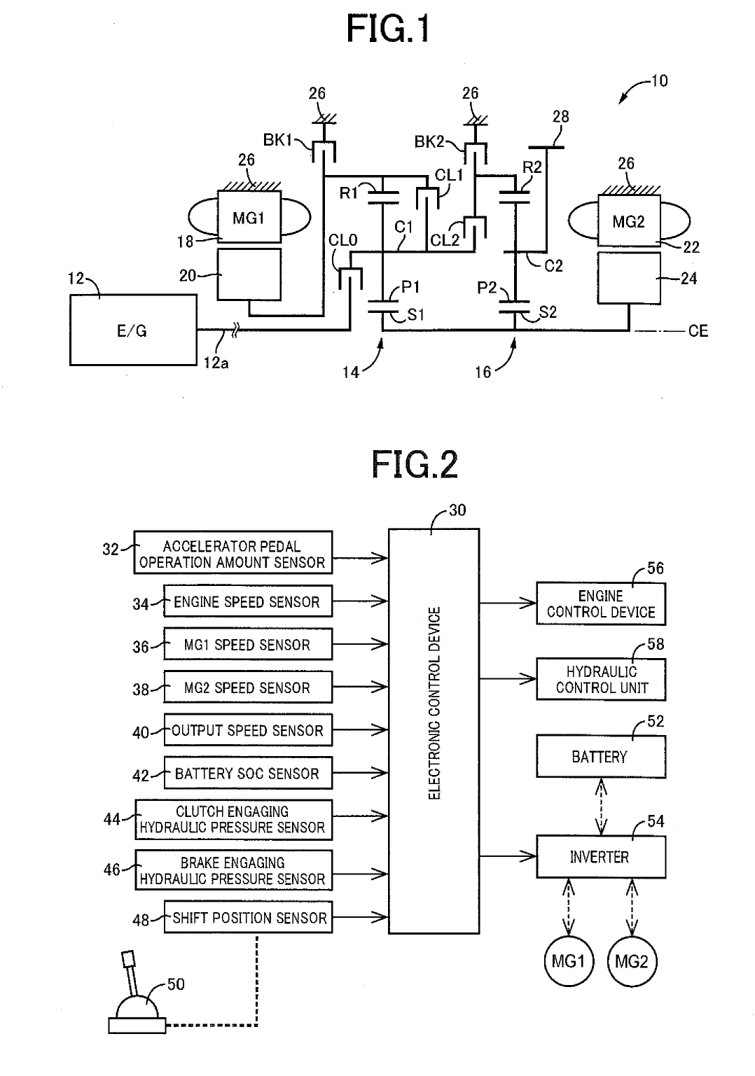

FIG. 1 is the schematic view showing an arrangement of a hybrid vehicle drive system 10 (hereinafter referred to simply as a “drive system 10”) to which the present invention is suitably applicable. As shown in FIG. 1, the drive system 10 according to the present embodiment is of a transversely installed type suitably used for an FF (front-engine front-drive) type vehicle, and is provided with a main vehicle drive power source in the form of an engine 12, a first electric motor MG1, a second electric motor MG2, a first differential mechanism in the form of a first planetary gear set 14, and a second differential mechanism in the form of a second planetary gear set 16, which are disposed on a common axis CE. In the following description of the embodiments, the direction of extension of this axis CE will be referred to as an “axial direction”. The drive system 10 is constructed substantially symmetrically with respect to the axis CE. In FIG. 1, a lower half of the drive system 10 is not shown. This applies to the other figures showing the other embodiments.

The engine 12 is an internal combustion engine such as a gasoline engine, which is operable to generate a drive force by combustion of a fuel such as a gasoline injected into its cylinders. Each of the first and second electric motors MG1 and MG2 is a so-called motor/generator having a function of a motor operable to generate a drive force, and a function of an electric generator operable to generate a reaction force, and is provided with a stator 18, 22 connected to a stationary member in the form of a housing (casing) 26, and a rotor 20, 24 disposed radially inwardly of the stator 18, 22.

The first planetary gear set 14 is a single-pinion type planetary gear set which has a gear ratio ρ1 and which includes rotary elements consisting of: a first rotary element in the form of a ring gear R1; a second rotary element in the form of a carrier C1 supporting a pinion gear P1 such that the pinion gear P1 is rotatable about its axis and the axis of the planetary gear set; and a third rotary element in the form of a sun gear S1 meshing with the ring gear R1 through the pinion gear P1. The second planetary gear set 16 is a single-pinion type planetary gear set which has a gear ratio ρ2 and which includes rotary elements consisting of: a first rotary element in the form of a ring gear R2; a second rotary element in the form of a carrier C2 supporting a pinion gear P2 such that the pinion gear P2 is rotatable about its axis and the axis of the planetary gear set; and a third rotary element in the form of a sun gear S2 meshing with the ring gear R2 through the pinion gear P2.

In the first planetary gear set 14, the ring gear R1 is connected to the rotor 20 of the first electric motor MG1, and the carrier C1 is selectively connectable through a clutch CL0 to an output shaft of the engine 12 in the form of a crankshaft 12a, while the sun gear S1 is connected to the sun gear S2 of the second planetary gear set 16 and the rotor 24 of the second electric motor MG2. In the second planetary gear set 16, the carrier C2 is connected to an output rotary member in the form of an output gear 28. A drive force received by the output gear 28 is transmitted to a pair of right and left drive wheels (not shown) through a differential gear device and axles (not shown). A torque received by the drive wheels from a roadway surface during running of the hybrid vehicle is transmitted from the output gear 28 to the drive system 10 through the differential gear device and axles.

The clutch CL0 for selectively connecting and disconnecting the carrier C1 of the first planetary gear set 14 to and from the crankshaft 12a of the engine 12 is disposed between the crankshaft 12a and the carrier C1. A clutch CL1 for selectively connecting and disconnecting the carrier C1 to and from the ring gear R1 is disposed between the carrier C1 and the ring gear R1. A clutch CL2 for selectively connecting and disconnecting the carrier C1 to and from the ring gear R2 of the second planetary gear set 16 is disposed between the carrier C1 and the ring gear R2. A brake BK1 for selectively connecting the ring gear R1 to the stationary member in the form of the housing 26 is disposed between the ring gear R1 and the housing 26. A brake BK2 for selectively connecting the ring gear R2 to the housing 26 is disposed between the ring gear R2 and the housing 26.

In the drive system 10 constructed as described above, the carrier C1 and the ring gear R1 of the first planetary gear set 14 are connected to each other through the clutch CL1 placed in the engaged state, so that the rotary elements of the first planetary gear set 14 are rotated as a single unit by a rotary motion received from the engine 12, and a ratio of an output speed of the first planetary gear set 14 to a speed of the rotary motion received from the engine 12 is held constant. In the engaged state of the brake BK1, the ring gear R1 of the first planetary gear set 14 is fixed to the housing 26, so that the ratio of the output speed of the first planetary gear set 14 to the speed of the rotary motion received from the engine 12 is held constant. In other words, the differential function of the first planetary gear set 14 with respect to the rotary motion received from the engine 12 is limited when the clutch CL1 or the brake BK1 is placed in the engaged state, so that a ratio of the output speed of the first planetary gear set 14 to its input speed is held at a predetermined constant value. Namely, each of the clutch CL1 and the brake BK1 provided in the present embodiment functions as a coupling element which is placed in the engaged state to hold constant the ratio of the output speed of the first planetary gear set 14 to the speed of the rotary motion received from the engine 12.

In the present embodiment, the clutch CL2 functions as a clutch for selectively connecting the carrier C1 (second rotary element) of the first planetary gear set 14 and the ring gear R2 (first rotary element) of the second planetary gear set 16 to each other, while the brake BK2 functions as a brake for selectively fixing the ring gear R2 of the second planetary gear set 16 (which is selectively connected to the carrier C1 through the clutch CL2) to the stationary member in the form of the housing 26. The differential device comprising the first and second planetary gear sets 14 and 16 comprises four rotary components when the clutch CL2 disposed between the carrier C1 of the first planetary gear set 14 and the ring gear R2 of the second planetary gear set 16 is placed in the engaged state. It is noted that the drive system 10 need not be provided with the clutch CL0. That is, in the absence of the clutch CL0, the crankshaft 12a of the engine 12 may be directly connected to the carrier C1 of the first planetary gear set 14, or indirectly through a damper, for instance.

Each of the clutches CL0, CL1 and CL2 (hereinafter collectively referred to as “clutches CL” unless otherwise specified), and the brakes BK1 and BK2 (hereinafter collectively referred to as “brakes BK” unless otherwise specified) is preferably a hydraulically operated coupling device the operating state of which is controlled (which is engaged and released) according to a hydraulic pressure applied thereto from a hydraulic control unit 58. While wet multiple-disc type frictional coupling devices are preferably used as the clutches CL and brakes BK, meshing type coupling devices, namely, so-called dog clutches (claw clutches) may also be used. Alternatively, the clutches CL and brakes BK may be electromagnetic clutches, magnetic powder clutches and any other clutches the operating states of which are controlled (which are engaged and released) according to electric commands generated from an electronic control device 30.

FIG. 2 is the block diagram illustrating major portions of a control system provided to control the drive system 10. The electronic control device 30 shown in FIG. 2 is a so-called microcomputer which incorporates a CPU, a ROM, a RAM and an input-output interface and which is operable to perform signal processing operations according to programs stored in the ROM while utilizing a temporary data storage function of the RAM, to implement various drive controls of the drive system 10, such as a drive control of the engine 12 and hybrid drive controls of the first and second electric motors MG1 and MG2. In the present embodiment, the electronic control device 30 serves as a control apparatus for the drive system 10. The electronic control device 30 may be constituted by mutually independent control units as needed for respective controls such as an output control of the engine 12 and drive controls of the first and second electric motors MG1 and MG2.

As indicated in FIG. 2, the electronic control device 30 is configured to receive various signals from sensors and switches provided in the drive system 10. Namely, the electronic control device 30 receives: an output signal of an accelerator pedal operation amount sensor 32 indicative of an operation amount or angle A_{CC} of an accelerator pedal (not shown), which corresponds to a vehicle output required by a vehicle operator; an output signal of an engine speed sensor 34 indicative of an engine speed N_{E}, that is, an operating speed of the engine 12; an output signal of an MG1 speed sensor 36 indicative of an operating speed N_{MG1} of the first electric motor MG1; an output signal of an MG2 speed sensor 38 indicative of an operating speed N_{MG2} of the second electric motor MG2; an output signal of an output speed sensor 40 indicative of a rotating speed N_{OUT} of the output gear 28, which corresponds to a running speed V of the hybrid vehicle; an output signal of a battery SOC sensor 42 indicative of a stored electric energy amount (state of charge) SOC of a battery 52; an output signal of a clutch engaging hydraulic pressure sensor 44 indicative of a hydraulic pressure P_{CL1} to be applied to the clutch CL1; an output signal of a brake engaging hydraulic pressure sensor 46 indicative of a hydraulic pressure P_{BK1} to be applied to the brake BK1; and an output signal of a shift position sensor 48 indicative of a presently selected operating position P_{S} of a shift lever of a manually operated shifting device 50.

The electronic control device 30 is also configured to generate various control commands to be applied to various portions of the drive system 10. Namely, the electronic control device 30 applies, to an engine control device 56, engine output control commands for controlling the output of the engine 12, which commands include: a fuel injection amount control signal to control an amount of injection of a fuel by a fuel injecting device into an intake pipe; an ignition control signal to control a timing of ignition of the engine 12 by an igniting device; and an electronic throttle valve drive control signal to control a throttle actuator for controlling an opening angle θ_{TH} of an electronic throttle valve. Further, the electronic control device 30 applies command signals to an inverter 54, for controlling operations of the first and second electric motors MG1 and MG2, so that the first and second electric motors MG1 and MG2 are operated with electric energies supplied thereto from the battery 52 through the inverter 54 according to the command signals to control outputs (output torques) of the electric motors MG1 and MG2. Electric energies generated by the first and second electric motors MG1 and MG2 are supplied to and stored in the battery 52 through the inverter 54. Further, the electronic control device 30 applies command signals for controlling the operating states of the clutches CL and brakes BK, to linear solenoid valves and other electromagnetic control valves provided in the hydraulic control unit 58, so that hydraulic pressures generated by those electromagnetic control valves are controlled to control the operating states of the clutches CL and brakes BK.

An operating state of the drive system 10 is controlled through the first and second electric motors MG1 and MG2, such that the drive system 10 functions as an electrically controlled differential portion whose difference of input and output speeds is controllable. For example, an electric energy generated by the first electric motor MG1 is supplied to the battery 52 or the second electric motor MG2 through the inverter 54. Namely, a major portion of the drive force of the engine 12 is mechanically transmitted to the output gear 28, while the remaining portion of the drive force is consumed by the first electric motor MG1 operating as the electric generator, and converted into the electric energy; which is supplied to the second electric motor MG2 through the inverter 54, so that the second electric motor MG2 is operated to generate a drive force to be transmitted to the output gear 28. Components associated with the generation of the electric energy and the consumption of the generated electric energy by the second electric motor MG2 constitute an electric path through which a portion of the drive force of the engine 12 is converted into an electric energy which is converted into a mechanical energy.

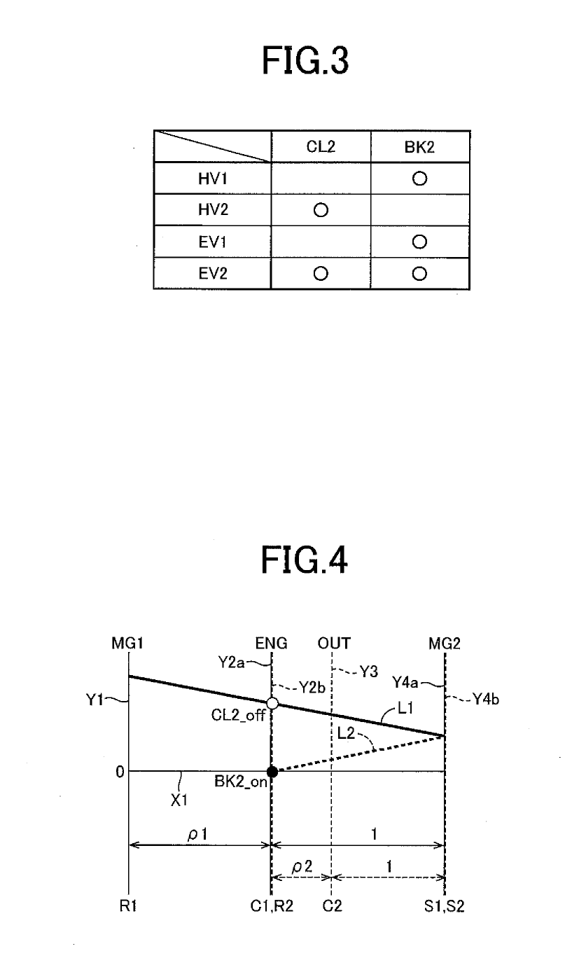

In the hybrid vehicle provided with the drive system 10 constructed as described above, a selected one of a plurality of vehicle drive modes is established according to the operating states of the engine 12 and the first and second electric motors MG1 and MG2, and the operating states of the clutches CL and brakes BK. FIG. 3 is the table indicating combinations of the operating states of the clutch CL2 and brake BK2, which correspond to the respective four vehicle drive modes of the drive system 10. In this table, “o” marks represent the engaged states of the clutch CL2 and brake BK2 while blanks represent their released states. Drive modes EV1 and EV2 indicated in FIG. 3 are EV drive modes in which the engine 12 is held at rest while at least one of the first and second electric motors MG1 and MG2 is used as a vehicle drive power source. Drive modes HV1 and HV2 are hybrid drive modes in which the engine 12 is operated as the vehicle drive power source while the first and second electric motors MG1 and MG2 are operated as needed to generate a vehicle drive force and/or an electric energy. In these hybrid drive modes, at least one of the first and second electric motors MG1 and MG2 can be operated to generate a reaction force or placed in a non-loaded free state.

As indicated in FIG. 3, the drive system 10 is placed in the hybrid drive mode HV1 in the engaged state of the brake BK2 and in the released state of the clutch CL2, and placed in the hybrid drive mode HV2 in the released state of the brake BK2 and in the engaged state of the clutch CL2. Further, the drive system 10 is placed in the EV drive mode EV1 in the engaged state of the brake BK2 and in the released state of the clutch CL2, and placed in the EV drive mode EV2 in the engaged states of both of the clutch CL2 and brake BK2.

While the drive system 10 in the present embodiment is placed in one of the four different drive modes as indicated in FIG. 3, the drive system 10 may be configured to be placed in a selected one of a plurality of constant-speed-ratio drive modes, according to a selected one of different combinations of the operating states of the clutch CL1 and the brake BK1, for instance. In the constant-speed-ratio drive modes, the drive system 10 has respective different speed values of a speed ratio of a power transmitting path from the engine 12 to the output gear 28. The clutch CL1 and the brake BK1 provided in the drive system 10 are placed in the engaged or released state as needed depending upon the running condition of the hybrid vehicle provided with the drive system 10. The following description of the plurality of drive modes corresponding to the respective combinations of the operating states of the clutch CL2 and brake BK2 indicated in FIG. 3 is based on an assumption that the clutch CL1 and brake BK1 are both placed in the released states.

FIGS. 4-6 are the collinear charts having straight lines which permit indication thereon of relative rotating speeds of the various rotary components of the drive system 10 (rotary elements of the first and second planetary gear sets 14 and 16), in respective different states of connection of the rotary elements corresponding to the respective different combinations of the operating states of the clutch CL2 and brake BK2. These collinear charts are defined in a two-dimensional coordinate system having a horizontal axis along which relative gear ratios ρ of the first and second planetary gear sets 14 and 16 are taken, and a vertical axis along which the relative rotating speeds of the rotary elements are taken. The collinear charts indicate the relative rotating speeds when the output gear 28 is rotated in the positive direction to drive the hybrid vehicle in the forward direction. A horizontal line X1 represents the rotating speed of zero, while vertical lines Y1, Y2a, Y2b, Y3, Y4a and Y4b arranged in the order of description in the rightward direction represent the respective relative rotating speeds of the various rotary elements. Namely, a solid line Y1 represents the rotating speed of the ring gear R1 of the first planetary gear set 14 (operating speed of the first electric motor MG1), and a solid line Y2a represents the rotating speed of the carrier C1 of the first planetary gear set 14 (operating speed of the engine 12), while a broken line Y2b represents the rotating speed of the ring gear R2 of the second planetary gear set 16. A broken line Y3 represents the rotating speed of the carrier C2 of the second planetary gear set 16 (output gear 28), and a solid line Y4a represents the rotating speed of the sun gear S1 of the first planetary gear set 14, while a broken line Y4b represents the rotating speed of the sun gear S2 of the second planetary gear set 16 (operating speed of the second electric motor MG2). In FIGS. 4-6, the vertical lines Y2a and Y2b are superimposed on each other, while the vertical lines Y4a and Y4b are superimposed on each other. Since the sun gears S1 and S2 are connected to each other, the relative rotating speeds of the sun gears S1 and S2 represented by the vertical lines Y4a and Y4b are equal to each other.

In FIGS. 4-6, a solid line L1 represents the relative rotating speeds of the three rotary elements of the first planetary gear set 14, while a broken line L2 represents the relative rotating speeds of the three rotary elements of the second planetary gear set 16. Distances between the vertical lines Y1-Y4 (Y2b-Y4b) are determined by the gear ratios p1 and p2 of the first and second planetary gear sets 14 and 16. Described more specifically, regarding the vertical lines Y1, Y2a and Y4a corresponding to the respective three rotary elements of the first planetary gear set 14, a distance between the vertical lines Y2a and Y4a respectively corresponding to the carrier C1 and the sun gear S1 corresponds to “1”, while a distance between the vertical lines Y1 and Y2a respectively corresponding to the ring gear R1 and the carrier C1 corresponds to the gear ratio “ρ1”. Regarding the vertical lines Y2b, Y3 and Y4b corresponding to the respective three rotary elements of the second planetary gear set 16, a distance between the vertical lines Y3 and Y4b respective corresponding to the carrier C2 and the sun gear S2 corresponds to “1”, while a distance between the vertical lines Y2b and Y3 respectively corresponding to the ring gear R2 and the carrier C2 corresponds to the gear ratio “ρ2”. The drive modes of the drive system 10 will be described by reference to FIGS. 4-6.

The collinear chart of FIG. 4 corresponds to the drive mode HV1 of the drive system 10, which is preferably the hybrid drive mode in which the engine 12 is used as the vehicle drive power source while the first and second electric motors MG1 and MG2 are operated to generate a drive force and/or an electric energy as needed. Described by reference to this collinear chart of FIG. 4, the carrier C1 of the first planetary gear set 14 and the ring gear R2 of the second planetary gear set 16 are rotatable relative to each other in the released state of the clutch CL2. In the engaged state of the brake BK2, the ring gear R2 of the second planetary gear set 16 is connected to the stationary member in the form of the housing 26, so that the rotating speed of the ring gear R2 is held zero. In this drive mode HV1, the engine 12 is operated to generate an output torque by which the output gear 28 is rotated. At this time, the first electric motor MG1 is operated to generate a reaction torque in the first planetary gear set 14, so that the output of the engine 12 can be transmitted to the output gear 28. In the second planetary gear set 16, the carrier C2, that is, the output gear 28 is rotated in the positive direction by a positive torque (i.e., a torque acting in a positive direction) generated by the second electric motor MG2 in the engaged state of the brake BK2.

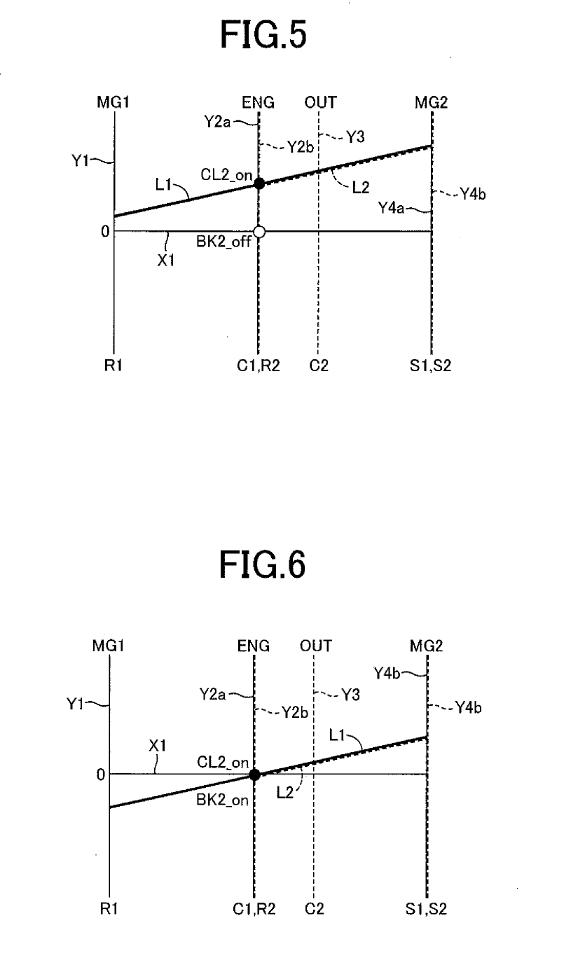

The collinear chart of FIG. 5 corresponds to the drive mode HV2 of the drive system 10, which is preferably the hybrid drive mode in which the engine 12 is used as the vehicle drive power source while the first and second electric motors MG1 and MG2 are operated as needed to generate a vehicle drive force and/or an electric energy. Described by reference to this collinear chart of FIG. 5, the carrier C1 of the first planetary gear set 14 and the ring gear R2 of the second planetary gear set 16 are not rotatable relative to each other, in the engaged state of the clutch CL2, that is, the carrier C1 and the ring gear R2 are integrally rotated as a single rotary component in the engaged state of the clutch CL2. The sun gears S1 and S2, which are connected to each other, are integrally rotated as a single rotary component. Namely, in the drive mode HV2 of the drive system 10, the first and second planetary gear sets 14 and 16 function as a differential device comprising a total of four rotary components. That is, the drive mode HV2 is a composite split mode in which the four rotary components are connected to each other in the order of description in the rightward direction as seen in FIG. 5. The four rotary components consist of: the ring gear R1 (connected to the first electric motor MG1); a rotary member consisting of the carrier C1 and the ring gear R2 connected to each other (and connected to the engine 12); the carrier C2 (connected to the output gear 28); and a rotary member consisting of the sun gears S1 and S2 connected to each other (and connected to the second electric motor MG2).

In the drive mode HV2, the carrier C1 of the first planetary gear set 14 and the ring gear R2 of the second planetary gear set 16 are connected to each other in the engaged state of the clutch CL2, so that the carrier C1 and the ring gear R2 are rotated integrally with each other. Accordingly, either one or both of the first and second electric motors MG1 and MG2 can receive a reaction force corresponding to the output of the engine 12. Namely, one or both of the first and second electric motors MG1 and MG2 can be operated to receive the reaction force during an operation of the engine 12, and each of the first and second electric motors MG1 and MG2 can be operated at an operating point assuring a relatively high degree of operating efficiency, and/or with a reduced degree of torque limitation due to heat generation.

The collinear chart of FIG. 4 also corresponds to the drive mode EV1 of the drive system 10, which is preferably the EV drive mode in which the engine 12 is held at rest while the second electric motor MG2 is used as the vehicle drive power source. Described by reference to this collinear chart of FIG. 4, the carrier C1 of the first planetary gear set 14 and the ring gear R2 of the second planetary gear set 16 are rotatable relative to each other in the released state of the clutch CL2. Further, in the engaged state of the brake BK2, the ring gear R2 of the second planetary gear set 16 is connected to the stationary member in the form of the housing 26, so that the rotating speed of the ring gear R2 is held zero. In this drive mode EV1, the carrier C2, that is, the output gear 28 is rotated in the positive direction by a positive torque (i.e., a torque acting in a positive direction) generated by the second electric motor MG2 in the second planetary gear set 16. Namely, the hybrid vehicle provided with the drive system 10 can be driven in the forward direction with the positive torque generated by the second electric motor MG2. In this case, the first electric motor MG1 is preferably held in a free state.

The collinear chart of FIG. 6 corresponds to the chive mode EV2 of the drive system 10, which is preferably the EV drive mode in which the engine 12 is held at rest while at least one of the first and second electric motors MG1 and MG2 is used as the vehicle drive power source. Described by reference to this collinear chart of FIG. 6, the carrier C1 of the first planetary gear set 14 and the ring gear R2 of the second planetary gear set 16 are not rotatable relative to each other in the engaged state of the clutch CL2. Further, in the engaged state of the brake BK2, the ring gear R2 of the second planetary gear set 16 and the carrier C1 of the first planetary gear set 14 which is connected to the ring gear R2, are connected to the stationary member in the form of the housing 26, so that the rotating speeds of the ring gear R2 and the carrier C1 are held zero. In this drive mode EV2, the rotating directions of the ring gear R1 and the sun gear S1 of the first planetary gear set 14 are opposite to each other. Namely, the carrier C2, that is, the output gear 28 is rotated in the positive direction by a negative torque (acting in the negative direction) generated by the first electric motor MG1, and/or a positive torque (acting in the positive direction) generated by the second electric motor MG2. That is, the hybrid vehicle provided with the drive system 10 can be driven in the forward direction when the torque is generated by at least one of the first and second electric motors MG1 and MG2.

In the drive mode EV2, at least one of the first and second electric motors MG1 and MG2 may be operated as the electric generator. In this case, one or both of the first and second electric motors MG1 and MG2 may be operated to generate a vehicle drive force (torque), at an operating point assuring a relatively high degree of operating efficiency, and/or with a reduced degree of torque limitation due to heat generation. Further, at least one of the first and second electric motors MG1 and MG2 may be held in a free state, when the generation of an electric energy by a regenerative operation of the electric motors MG1 and MG2 is inhibited due to full charging of the battery 52. Namely, the drive mode EV2 can be established under various running conditions of the hybrid vehicle, or may be kept for a relatively long length of time. Accordingly, the drive mode EV2 is advantageously provided on a hybrid vehicle such as a plug-in hybrid vehicle, which is frequently placed in an EV drive mode.

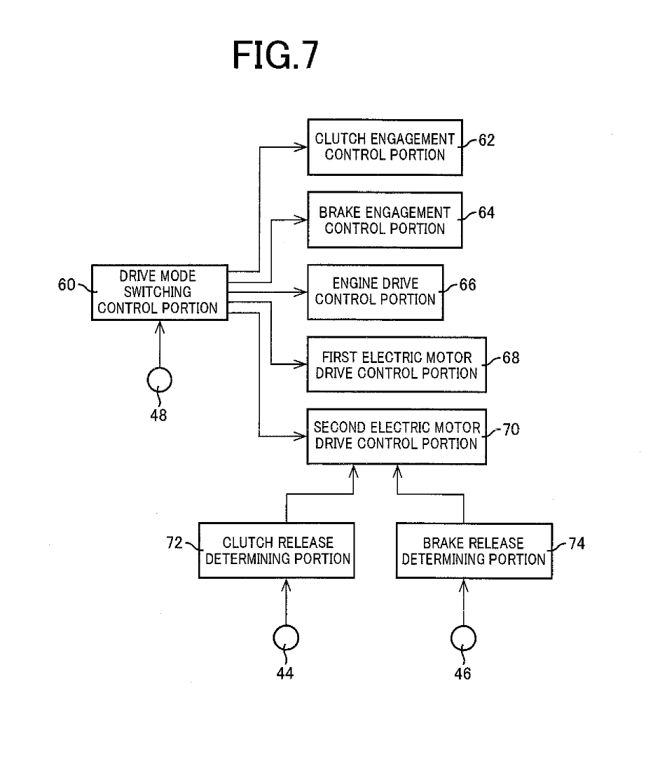

FIG. 7 is the functional block diagram illustrating major control functions of the electronic control device 30. The electronic control device 30 includes a drive mode switching control portion 60, a clutch engagement control portion 62, a brake engagement control portion 64, an engine drive control portion 66, a first electric motor drive control portion 68, a second electric motor drive control portion 70, a clutch release determining portion 72, and a brake release determining portion 74. The drive mode switching control portion 60 shown in FIG. 7 is configured to determine the drive mode of the drive system 10 that should be established. Described more specifically, the drive mode switching control portion 60 selects one of the four drive modes indicated in FIG. 3, that is, the drive modes HV1, HV2, EV1 and EV2, on the basis of the accelerator pedal operation amount A_{CC} detected by the accelerator pedal operation amount sensor 32 which corresponds to the required vehicle drive force, the vehicle running speed V corresponding to the output speed detected by the output speed sensor 40, the stored electric energy amount SOC of the battery 52 detected by the battery SOC sensor 42, etc., and according to a predefined drive mode switching map.

The clutch engagement control portion 62 is configured to control the operating states of the clutches CL1 and CL2 through the hydraulic control unit 58. Described more specifically, the clutch engagement control portion 62 controls output hydraulic pressures of respective solenoid control valves provided in the hydraulic control unit 58 to control the clutches CL1 and CL2, for controlling hydraulic pressures P_{CL1} and P_{CL2} which determine the operating states (torque capacities) of the respective clutches CL1 and CL2. The clutch engagement control portion 62 is preferably configured to control the operating states i.e., the torque capacities of the clutches CL1 and CL2, according to the drive mode selected by the drive mode switching control portion 60. Namely, the clutch engagement control portion 62 is basically configured to control the torque capacities of the clutches CL1 and CL2, so as to place the clutch CL1 in the released state and to place the clutch CL2 in the engaged state when the drive mode switching control portion 60 has determined that the drive system 10 should be switched to the drive mode HV2 or EV2, and so as to place the clutches CL1 and CL2 in the released state when the drive mode switching control portion 60 has determined that the drive system 10 should be switched to the drive mode HV1 or EV1.

The brake engagement control portion 64 is configured to control the operating states of the brakes BK1 and BK2 through the hydraulic control unit 58. Described more specifically, the brake engagement control portion 64 controls output hydraulic pressures of solenoid control valves provided in the hydraulic control unit 58 to control the brakes BK1 and BK2, for controlling hydraulic pressures P_{BK1} and P_{BK2} which determine the operating states (torque capacities) of the respective brakes BK1 and BK2. Namely, the brake engagement control portion 64 is preferably configured to control the operating states i.e., the torque capacities of the brakes BK1 and BK2, according to the drive mode selected by the drive mode switching control portion 60. Namely, the brake engagement control portion 64 is basically configured to control the torque capacity of the brake BK2, so as to place the brake BK2 in the engaged state while to place the brake BK1 in the released state when the drive mode switching control portion 60 has determined that the drive system 10 should be switched to the drive mode HV1, EV1 or EV2, and to control the torque capacities of the brakes BK1 and BK2, so as to place both of the brakes BK1 and BK2 in the released state when the drive mode switching control portion 60 has determined that the drive system 10 should be switched to the drive mode HV2.

The engine drive control portion 66 is configured to control an operation of the engine 12 through the engine control device 56. For instance, the engine drive control portion 66 commands the engine control device 56 to control an amount of supply of a fuel by the fuel injecting device of the engine 12 into an intake pipe, a timing of ignition (ignition timing) of the engine 12 by the igniting device, and the opening angle θ_{TH} of the electronic throttle valve, so that the engine 12 generates a required output, that is, a target torque (target engine output).

The first electric motor drive control portion 68 is configured to control an operation of the first electric motor MG1 through the inverter 54. For example, the first electric motor drive control portion 68 controls an amount of an electric energy to be supplied from the battery 52 to the first electric motor MG1 through the inverter 54, so that the first electric motor MG1 generates a required output, that is, a target torque (target first electric motor output). The second electric motor drive control portion 70 is configured to control an operation of the second electric motor MG2 through the inverter 54. For example, the second electric motor drive control portion 70 controls an amount of an electric energy to be supplied from the battery 52 to the second electric motor MG2 through the inverter 54, so that the second electric motor MG2 generates a required output, that is, a target torque (target second electric motor output).

In the hybrid drive modes in which the engine 12 is operated while the first and second electric motors MG1 and MG2 are used as the vehicle drive power source, a required vehicle drive force to be generated by the drive system 10 (output gear 28) is calculated on the basis of the accelerator pedal operation amount A_{CC} detected by the accelerator pedal operation amount sensor 32, and the vehicle running speed V corresponding to the output speed N_{OUT} detected by the output speed sensor 40. The operations of the first and second electric motors MG1 and MG2 are controlled by the first and second electric motor drive control portions 68 and 70, each corresponding to the electric motor drive control portion of the present invention, while the operation of the engine 12 is controlled by the engine chive control portion 66, so that the calculated required vehicle drive force is obtained by the output torque of the engine 12 and the output torques of the first and second electric motors MG1 and MG2.

The clutch release determining portion 72 is configured to determine whether the clutch CL1 is placed in the released state. For instance, the clutch release determining portion 72 determines that the clutch CL1 is placed in the released state, when the hydraulic pressure P_{CL1} to be applied to the hydraulic actuator provided for the clutch CL1 is lower than a predetermined threshold value. In other words, the clutch release determining portion 72 determines that the clutch CL1 is not placed in the released state, when the hydraulic pressure P_{CL1} detected by the clutch engaging hydraulic pressure sensor 44 is equal to or higher than the predetermined threshold value. That is, in this embodiment, the clutch release determining portion 72 corresponds to a detecting portion configured to detect that the coupling element in the form of the clutch CL1 is placed in the released state. Alternatively, the clutch release determining portion 72 may be configured to make the above-indicated determination depending upon whether a hydraulic pressure switch which is turned on and off according to the hydraulic pressure P_{CL1} is placed in the on state or the off state. In this case, the hydraulic pressure switch functions as the detecting portion. Further alternatively, the clutch release determining portion 72 may be configured to make the above-indicated determination depending upon a difference between the input and output speeds of the clutch CL1, that is, a difference between the rotating speeds of the carrier C1 and the ring gear R1 of the first planetary gear set 14.

The brake release determining portion 74 is configured to determine whether the brake BK1 is placed in the released state. For instance, the brake release determining portion 74 determines that the brake BK1 is placed in the released state, when the hydraulic pressure P_{BK1} to be applied to the hydraulic actuator provided for the brake BK1 is lower than a predetermined threshold value. In other words, the brake release determining portion 74 determines that the brake BK1 is not placed in the released state, when the hydraulic pressure P_{BK1} detected by the brake engaging hydraulic pressure sensor 46 is equal to or higher than the predetermined threshold value. That is, in this embodiment, the brake release determining portion 74 corresponds to a detecting portion configured to detect that the coupling element in the form of the brake BK1 is placed in the released state. Alternatively, the brake release determining portion 74 may be configured to make the above-indicated determination depending upon whether a hydraulic pressure switch which is turned on and off according to the hydraulic pressure P_{BK1} is placed in the on state or the off state. In this case, the hydraulic pressure switch functions as the detecting portion. Further alternatively, the brake release determining portion 74 may be configured to make the above-indicated determination depending upon the rotating speed of the ring gear R1 of the first planetary gear set 14 relative to the housing 26.

The drive mode switching control portion 60 is configured to place both of the clutch CL1 and the brake BK1 in the released states to place the drive system 10 in a reverse drive mode in which the hybrid vehicle is driven in the reverse direction primarily with a torque generated by the second electric motor MG2. Preferably, the drive mode switching control portion 60 is configured to place the brake BK2 in the engaged state in the reverse drive mode. Namely, the drive mode switching control portion 60 commands the clutch engagement control portion 62 to place the clutch CL1 in the released state, commands the brake engagement control portion 64 to place the brake BK1 in the released state and to place the brake BK2 in the engaged state, and commands the second electric motor drive control portion 70 to be operated to generate a negative torque for rotating the output gear 28 in the reverse direction, when the presently selected operating position P_{S} of the shift lever of the manually operated shifting device 50 detected by the shift position sensor 48 is a reverse drive position R.

In the present embodiment, the direction of the torque generated by each of the first and second electric motors MG1 and MG2 to rotate the output gear 28 in a positive direction for driving the hybrid vehicle in the forward direction is referred to as a “positive direction”. In other words, the positive direction of the torques of the first and second electric motors MG1 and MG2 corresponds to a positive operating direction of the engine 12. Described more specifically by reference to the collinear charts of FIGS. 4-6, the positive direction of the torque generated by the first electric motor MG1 corresponds to an upward direction parallel to the vertical line Y1 along which the operating speed of the first electric motor MG1 is taken, while the negative direction of the torque corresponds to a downward direction parallel to the vertical line Y1. Similarly, the positive direction of the torque generated by the second electric motor MG2 corresponds to an upward direction parallel to the vertical line Y4 (Y4b) along which the operating speed of the second electric motor MG2 is taken, while the negative direction of the torque corresponds to a downward direction parallel to the vertical line Y4 (Y4b).

The collinear chart of FIG. 4 corresponds to the reverse drive mode of the drive system 10 in the present embodiment. In a state of the drive system 10 indicated in this collinear chart of FIG. 4, a torque generated by the second electric motor MG2 in the negative direction causes a change of the rotating speed of the output gear 28 in the negative or reverse direction, and the hybrid vehicle is driven in the reverse direction with the output gear 28 being rotated at a negative speed value. As indicated in FIG. 4, the differential function of the first planetary gear set 14 with respect to the rotary motion received from the engine 12 is permitted in the released states of both of the clutch CL1 and the brake BK1, so that the engine 12 and the second electric motor MG2 are permitted to be operated in the opposite directions.

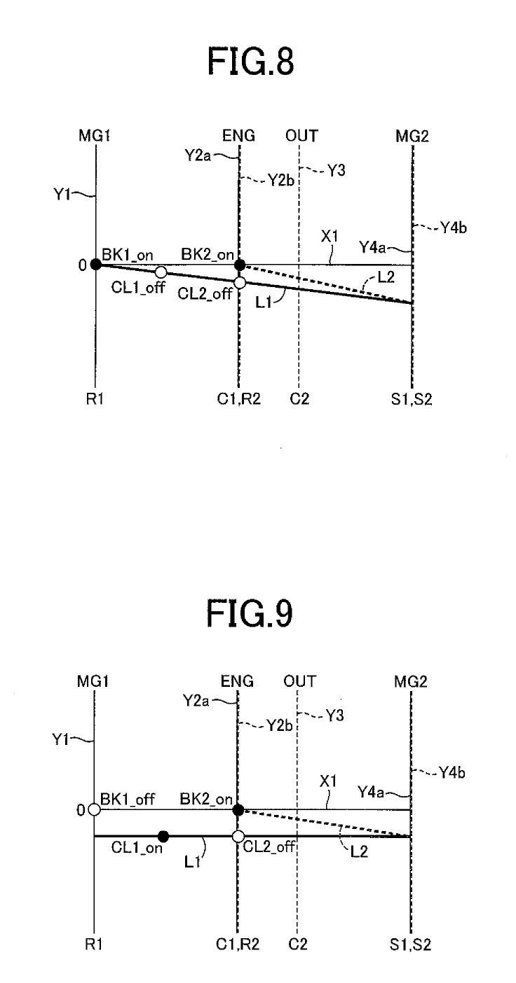

When at least one of the clutch CL1 and the brake BK1 is placed in the engaged state, the engine 12 and the second electric motor MG2 are operated in the same direction. The collinear chart of FIG. 8 indicates the rotating speeds of the rotary elements of the drive system 10 when the brake BK1 is placed in the engaged state while the drive system 10 is placed in the hybrid drive mode HV1 or the EV drive mode EV1. In the engaged state of the brake BK1 in which the ring gear R1 of the first planetary gear set 14 is fixed to the housing 26, a drive force received by the carrier C1 from the engine 12 is transmitted to the sun gear S2 of the second planetary gear set 16 after the rotary motion speed of the drive force is increased by the first planetary gear set 14. In engaged state of the brake BK2 in which the ring gear R2 of the second planetary gear set 16 is fixed to the housing 26, the drive force transmitted from the engine 12 to the sun gear S2 is transmitted from the carrier C2 to the output gear 28 after the rotary motion speed of the drive force is reduced by the second planetary gear set 16. As indicated in FIG. 8, the second electric motor MG2 is operated in the same direction as the engine 12 in the engaged state of the brake BK1, so that when the second electric motor MG2 is operated in the negative direction, the engine 12 is also operated in the negative or reverse direction.

The collinear chart of FIG. 9 indicates the rotating speeds of the rotary elements of the drive system 10 in the engaged state of the clutch CL1 in the hybrid drive mode HV1 or the EV drive mode EV1. In the engaged state of the clutch CL1, the rotary elements of the first planetary gear set 14 are rotated as a unit. That is, the first electric motor MG1 connected to the ring gear R1, the engine 12 connected to the carrier C1, and the second electric motor MG2 connected to the sun gear S1 (sun gear S2) are operated at the same speeds. Namely, the second electric motor MG2 is operated in the same direction as the engine 12, in the engaged state of the clutch CL1, as indicated in FIG. 9, so that when the second electric motor MG2 is operated in the negative direction, the engine 12 is also operated in the negative or reverse direction.

Since the engine 12 and the second electric motor MG2 are operated in the same direction when at least one of the clutch CL1 and the brake BK1 is placed in the engaged state, as described above by reference to FIGS. 8 and 9, there is a risk of an operation of the engine 12 in the reverse direction as a result of the operation of the second electric motor MG2 in the negative direction.

In view of the risk indicated above, the second electric motor drive control portion 70 according to the present embodiment is configured to initiate an operation of the second electric motor MG2 to generate a negative torque for rotating the output gear 28 in the reverse direction after detecting that the coupling elements in the form of the clutch CL1 and the brake BK1 have been placed in the released states, when the output gear 28 is required to be rotated in the reverse direction. For instance, when the drive mode switching control portion 60 determines that the drive system 10 should be switched to the reverse drive mode, as a result of an operation of the shift lever of the manually operated shifting device 50 to the reverse drive position R, the second electric motor drive control portion 70 initiates the operation of the second electric motor MG2 to generate the negative torque for rotating the output gear 28 in the reverse direction after the clutch release determining portion 72 has determined that the clutch CL1 is placed in the released state and after the brake release determining portion 74 has determined that the brake BK1 is placed in the released state. In other words, the second electric motor drive control portion 70 does not command the second electric motor MG2 to be operated to generate the negative torque, that is, inhibits the operation of the second electric motor MG2 to generate the negative torque, unless at least one of the affirmative determination by the clutch release determining portion 72 that the clutch CL1 is placed in the released state and the affirmative determination by the brake release determining portion 74 that the brake BK1 is placed in the released state is obtained, even if the drive mode switching control portion 60 has determined that the drive system 10 should be switched to the reverse drive mode.

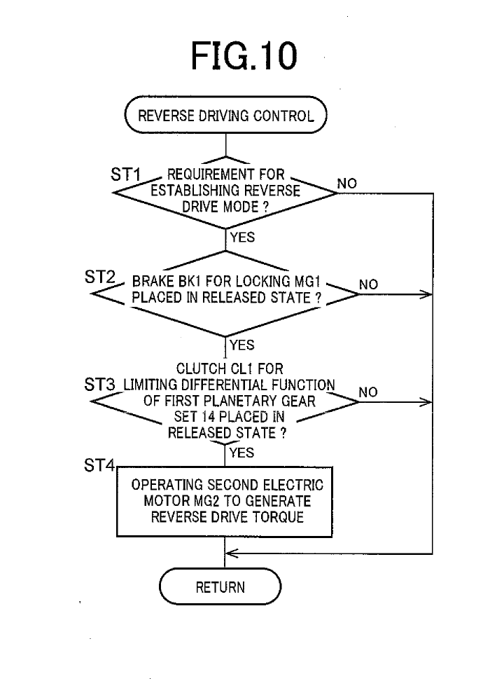

FIG. 10 is the flow chart illustrating a major portion of one example of a reverse driving control implemented by the electronic control device 30. This reverse driving control is implemented with a predetermined cycle time.

The reverse driving control is initiated with a step ST1 corresponding to the drive mode switching control portion 60, to determine whether the drive system 10 is required to be switched to the reverse drive mode, as a result of the operation of the shift lever of the manually operated shifting device 50 to the reverse drive position R, for example. If a negative determination is obtained in the step ST1, the present control routine is terminated. If an affirmative determination is obtained in the step ST1, the control flow goes to a step ST2 corresponding to the brake release determining portion 74, to determine whether the brake BK1 provided to fix the rotary element in the form of the ring gear R1 of the first planetary gear set 14 connected to the first electric motor MG1, to the stationary member in the form of the housing 26, is placed in the released state (not engaged state). This determination is made on the basis of the hydraulic pressure P_{BK1} detected by the brake engaging hydraulic pressure sensor 46. If a negative determination is obtained in the step ST2, the present control routine is terminated. If an affirmative determination is obtained in the step ST2, the control flow goes to a step ST3 corresponding to the clutch release determining portion 72, to determine whether the clutch CL1 provided to connect the carrier C1 and the ring gear R1 of the first planetary gear set 14 to each other for limiting the differential function of the first planetary gear set 14 is placed in the released state (not engaged state). This determination is made on the basis of the hydraulic pressure P_{CL1} detected by the clutch engaging hydraulic pressure sensor 44. If a negative determination is obtained in the step ST3, the present control routine is terminated. If an affirmative determination is obtained in the step ST3, the control flow goes to a step ST4 corresponding to the second electric motor drive control portion 70, to command the second electric motor MG2 to generate a negative torque as a reverse drive force for rotating the output gear 28 in the reverse direction for reverse driving of the hybrid vehicle. Then, the present routine is terminated.

The electronic control device 30 according to the illustrated embodiment is provided for controlling the hybrid vehicle drive system 10 including: the differential device which comprises the first differential mechanism in the form of the first planetary gear set 14 and the second differential mechanism in the form of the second planetary gear set 16 and which comprises the four rotary components (the rotating speeds of which are represented in a collinear chart); the engine 12, the first electric motor MG1, the second electric motor MG2 and the output rotary member in the form of the output gear 28 which are respectively connected to the four rotary components; and the coupling element in the form of the clutch CL1 or the brake BK1 which is placed in the engaged state to hold constant the ratio of the output speed of the first planetary gear set 14 (or the second planetary gear set 16) to the speed of a rotary motion received from the engine 12. The electronic control device 30 comprises: the detecting portions in the form of the clutch release determining portion 72 (step ST3) configured to detect that the clutch CL1 is placed in the released state, and the brake release determining portion 74 (step ST2) configured to detect that the brake BK1 is placed in the released state; and the electric motor drive control portion in the form of the second electric motor drive control portion 70 configured to initiate the operation of the second electric motor MG2 to generate a negative torque for a request to rotate the output rotary member in the form of the output gear 28 in the reverse direction for reverse driving of the hybrid vehicle, after the clutch release determining portion 72 and the brake release determining portion 74 have detected that the clutch CL1 and the brake BK1 are placed in the released states. Accordingly, it is possible to prevent the operations of the engine 12 and the second electric motor MG2 in the same direction, and to effectively prevent an operation of the engine 12 in the reverse direction as a result of an operation of the second electric motor MG2 to generate a negative torque for reverse driving of the hybrid vehicle. Namely, the electronic control device 30 provides a control apparatus for the hybrid vehicle drive system 10, which permits prevention of an operation of the engine 12 in the reverse direction during reverse driving of the hybrid vehicle.

The above-described coupling element is the brake BK1 configured to selectively fix the rotary element in the form of the ring gear R1 of the first planetary gear set 14 connected to the first electric motor MG1, to the stationary member in the form of the housing 26. Accordingly, it is possible to effectively prevent an operation of the engine 12 in the reverse direction, by operating the second electric motor MG2 to generate a negative torque for reverse driving of the hybrid vehicle after determining that the brake BK1 is placed the released state when the output gear 28 is required to be rotated in the reverse direction.

The above-described coupling element is the clutch CL1 which is placed in the engaged state to connect the carrier C1 and the ring gear R1 of the first planetary gear set 14 so as to limit the differential function of the first planetary gear set 14. Accordingly, it is possible to effectively prevent the operation of the engine 12 in the reverse direction, by operating the second electric motor MG2 to generate a negative torque for reverse driving of the hybrid vehicle after determining that the clutch CL1 is placed in the released state when the output gear 28 is required to be rotated in the reverse direction.

The drive system 10 to be controlled by the control apparatus in the form of the electronic control device 30 is configured such that the first differential mechanism in the form of the first planetary gear set 14 comprises the first rotary element in the form of the ring gear R1 connected to the first electric motor MG1, the second rotary element in the form of the carrier C1 connected to the engine 12, and the third rotary element in the form of the sun gear S1, while the second differential mechanism in the form of the second planetary gear set 16 comprises the first rotary element in the form of the ring gear R2, the second rotary element in the form of the carrier C2 and the third rotary element in the form of the sun gear S2, and such that the sun gear S1 of the first planetary gear set 14 and the sun gear S2 of the second planetary gear set 16 are connected to each other, and the carrier C2 of the second planetary gear set 16 is connected to the output rotary member in the form of the output gear 28, while the sun gear S2 of the second planetary gear set 16 is connected to the second electric motor MG2. Accordingly, the control apparatus permits prevention of the operation of the engine 12 in the reverse direction during reverse driving of the hybrid vehicle provided with the drive system 10 having a practical arrangement.

While the preferred embodiment of this invention has been described by reference to the drawings, it is to be understood that the invention is not limited to the details of the illustrated embodiments, but may be embodied with various changes which may occur without departing from the spirit of the invention.

### NOMENCLATURE OF REFERENCE SIGNS

10: Hybrid vehicle drive system
12: Engine
14: First planetary gear set (First differential mechanism)
16: Second planetary gear set (Second differential mechanism)
26: Housing (Stationary member)
28: Output gear (Output rotary member)
30: Electronic control device
72: Clutch release determining portion (Detecting portion)
74: Brake release determining portion (Detecting portion)
BK1: Brake (Coupling element)
C1: Carrier (Second rotary element)
C2: Carrier (Second rotary element)
CL1: Clutch (Coupling element)
MG1: First electric motor
MG2: Second electric motor
R1: Ring gear (First rotary element)
R2: Ring gear (First rotary element)
S1: Sun gear (Third rotary element)
S2: Sun gear (Third rotary element)

1. A control apparatus for a hybrid vehicle drive system including: a differential device which comprises a first differential mechanism and a second differential mechanism and which comprises four rotary components; an engine, a first electric motor, a second electric motor and an output rotary member which are respectively connected to said four rotary components; and a coupling element which is placed in an engaged state to hold constant a ratio of an output speed of said first differential mechanism or said second differential mechanism to a speed of a rotary motion received from said engine, the control apparatus comprising:
a detecting portion configured to detect that said coupling element is placed in a released state; and
an electric motor drive control portion configured to initiate an operation of said first electric motor or said second electric motor to generate a negative torque for rotating said output rotary member in a reverse direction for reverse driving request of the hybrid vehicle, after said detecting portion has detected that said coupling element is placed in the released state.

2. The control apparatus according to claim 1, wherein said coupling element is a brake configured to selectively fix the rotary component connected to said first electric motor or said second electric motor, to a stationary member.

3. The control apparatus according to claim 1, wherein said coupling element is a clutch which is placed in an engaged state to limit a differential function of said first differential mechanism or said second differential mechanism.

4. The control apparatus according to claim 1, wherein said first differential mechanism comprises a first rotary element connected to said first electric motor, a second rotary element connected to said engine, and a third rotary element, while said second differential mechanism comprises a first rotary element, a second rotary element and a third rotary element,
and wherein said third rotary element of said first differential mechanism and said third rotary element of said second differential mechanism are connected to each other, and said second rotary element of said second differential mechanism is connected to said output rotary member, while said third rotary element of said second differential mechanism is connected to said second electric motor.
